(19) United States
(12) Patent Application Publication
(10) Pub. No.: US 2019/0126891 A1
(43) Pub. Date: May 2, 2019

(54) WASHING DEVICE FOR ON-BOARD CAMERA

(71) Applicant: TOYODA GOSEI CO., LTD., Kiyosu-shi (JP)

(72) Inventor: Takeshi KONDO, Kiyosu-shi (JP)

(21) Appl. No.: 16/167,618

(22) Filed: Oct. 23, 2018

(30) Foreign Application Priority Data
Oct. 27, 2017 (JP) 2017-208663

(51) Int. Cl. B60S 1/52; B08B 3/02; B08B 5/02; B60S 1/48; B60S 1/54; B60R 16/08; G02B 27/00

(52) U.S. Cl. CPC B60S 1/52; B08B 3/02; B08B 5/02; B08B 2203/027; B60S 1/54; B60R 16/08; G02B 27/0006; B60S 1/481

(57) ABSTRACT

A washing device for on-board camera includes a spout port, a tank, and a controller. The spout nozzle is directed to the lens surface of a camera installed on a vehicle, and spouts a washing liquid and compressed air. The tank communicates with the spout port, and reserves the washing liquid and compressed air under pressurized condition. The controller controls the washing liquid and compressed air reserved in the tank so as to spout through the spout port.

### INCORPORATION BY REFERENCE

The present invention is based on Japanese Patent Application No. 2017-208663, filed on Oct. 27, 2017, the entire contents of which are incorporated herein by reference.

### BACKGROUND OF THE INVENTION

### 1. Field of the Invention

The present invention relates to a washing device for on-board camera, the washing device washing the lens face of a camera installed within a vehicle.

### 2. Description of the Related Art

Vehicles have been required to grasp or recognize the circumstances of their own surroundings. As a result, many vehicles have come to have on-board cameras, which shoot or make a video of images of their surroundings, in order to grasp or recognize the circumstances of their own surroundings. The on-board cameras may suffer from foreign matters, such as dirt, which have deposited on the lens surface when weather conditions are bad like during rainy weathers. The foreign matters deposited on the lens surface make it difficult for the on-board cameras to shoot or make a video of images of their surroundings. International Publication Gazette No. 2014/010580, for instance, discloses a washing device allowing the removal of foreign matters deposited on the lens surface of an on-board camera by washing.

The washing device for on-board camera, which International Publication Gazette No. 2014/010580 discloses, comprises a nozzle, primary and secondary tanks, and a compressed-air delivery means. The nozzle includes a discharge port for discharging a washing liquid and compressed air, a washing-liquid passage for leading the washing liquid to the discharge port, and an air passage for leading the compressed air to the discharge port. The primary and secondary tanks reserve the washing liquid. The compressed-air delivery means delivers the compressed air via air piping connected with the air passage.

The disclosed conventional washing device for on-board camera spouts the washing liquid, which is turned into a mist, onto the lens surface of an on-board camera together with the compressed air to wash away foreign matters. Alternatively, the disclosed conventional washing device drips the washing liquid onto the lens surface, namely, makes the washing liquid flow down along the lens surface, to wash away foreign matters.

### SUMMARY OF THE INVENTION

The disclosed conventional washing device, however, cannot remove foreign matters efficiently when it does not produce any pressure sufficiently enough for blowing out the washing liquid onto the lens surface of an on-board camera. If so, it is needed to increase the pressure for blowing out the washing liquid, but the increase in the pressure has been accompanied by increase in the used amount of the washing liquid. Moreover, the disclosed conventional washing device, which drips the washing liquid onto the lens surface, has been required to flow the washing liquid in a large volumetric amount for a long period of time in order to wash away foreign matters deposited on the lens face. In this instance, the used amount of the washing liquid has increased per washing operation.

The increase in the used amount of the washing liquid leads to increasing troublesome work for replenishing the washing liquid. Meanwhile, it has been investigated enlarging the volumetric capacity of a tank for reserving the washing liquid. However, it has been difficult to ensure a much larger space for the tank having an enlarged volumetric capacity in vehicles. The present invention has been developed in view of the aforementioned circumstances. It is therefore an object of the present invention to provide a washing device for on-board camera that allows demonstrating high washing performance while keeping down the increase in the used amount of the washing liquid.

For example, a washing device for on-board camera according to the present invention achieving the aforementioned object comprises washes a lens surface of a camera installed on a vehicle, and comprises:

a spout port directed to the lens surface, and spouting a washing liquid and compressed air;

a tank communicating with the spout port, and reserving the washing liquid and compressed air under pressurized condition; and

a controller controlling the washing liquid and compressed air reserved in the tank so as to spout through the spout port.

The washing device for on-board camera according to the present invention reserves the washing liquid and compressed air under pressurized condition in the tank. Moreover, the present washing device blows the pressurized washing liquid and compressed air onto the lens surface through the spout port. The thus constructed present washing device allows blowing the washing liquid with greater momentum onto the lens surface with a pressure exerted by the pressurized compressed air. The pressure exerted by the blowing washing liquid permits removing foreign matters deposited on the lens surface, namely, blowing them out. Consequently, the present washing device allows reducing the blowing amount of the washing liquid. That is, the present washing device permits demonstrating high washing performance while keeping down the used amount of the washing liquid.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a perspective view illustrating a vehicle which has a washing device for on-board camera according to First Embodiment of the present invention on-board.

FIG. 2 is a block diagram illustrating how the present washing device according to First Embodiment is constructed.

FIG. 3 is a partial cross-sectional front view illustrating how the present washing device according to First Embodiment is constructed at around its tank.

FIG. 4 is a cross-sectional view of the present washing device according First Embodiment viewed in the direction of the arrows “IV”-“IV” shown in FIG. 3.

FIG. 5 is a cross-sectional view of the present washing device according to First Embodiment in which a piston illustrated in FIG. 4 is moved.

FIG. 6 is a cross-sectional view of the present washing device according First Embodiment viewed in the direction of the arrows “VI”-“VI” shown in FIG. 3.

FIG. 7 is a block diagram illustrating how a washing device for on-board camera according to Second Embodiment of the present invention is constructed.

FIG. 8 is a front view illustrating how the present washing device according to Second Embodiment is constructed at around its tank.

FIG. 9 is a cross-sectional view of the present washing device according Second Embodiment viewed in the direction of the arrows “IX”-“IX” shown in FIG. 8.

FIG. 10 is a cross-sectional view of the present washing device according to Second Embodiment in which one of its valves illustrated in FIG. 8 is moved.

FIG. 11 is a cross-sectional view of the present washing device according to Second Embodiment in which another one of the valves in its nozzle illustrated in FIG. 8 is moved.

FIG. 12 is a cross-sectional view of the present washing device according Second Embodiment viewed in the direction of the arrows “XII”-“XII” shown in FIG. 8.

FIG. 13 is a block diagram illustrating how a washing device for on-board camera according to Third Embodiment of the present invention is constructed.

FIG. 14 is a perspective view illustrating a vehicle which has washing devices for on-board camera according to Modified Embodiment of the present invention on-board.

FIG. 15 is another perspective view illustrating the vehicle which has other present washing devices according to Modified Embodiment on-board.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Hereinafter, a washing device for on-board camera according to the present invention will be described in detail using specific embodiments. Note that the specific embodiments do not limit the present washing device at all because they only indicate some of modes to describe the present washing device in detail.

### First Embodiment

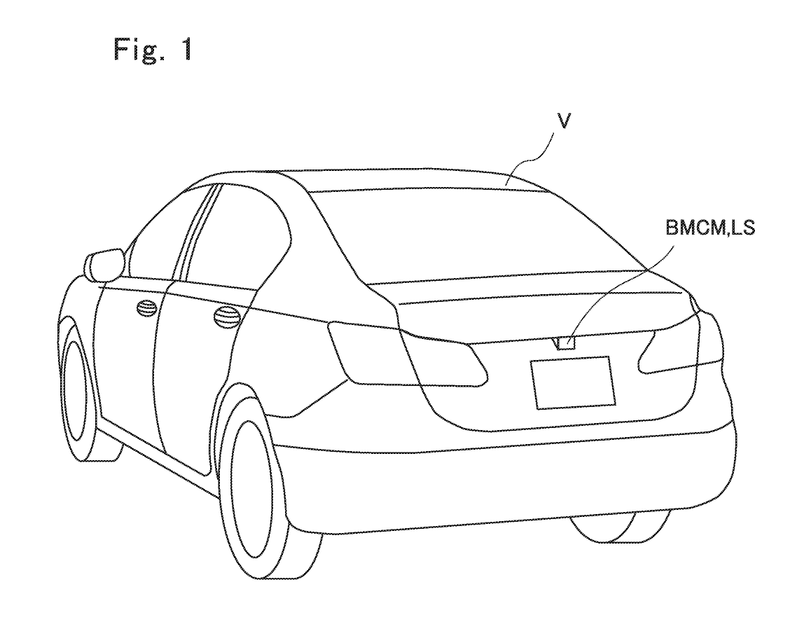

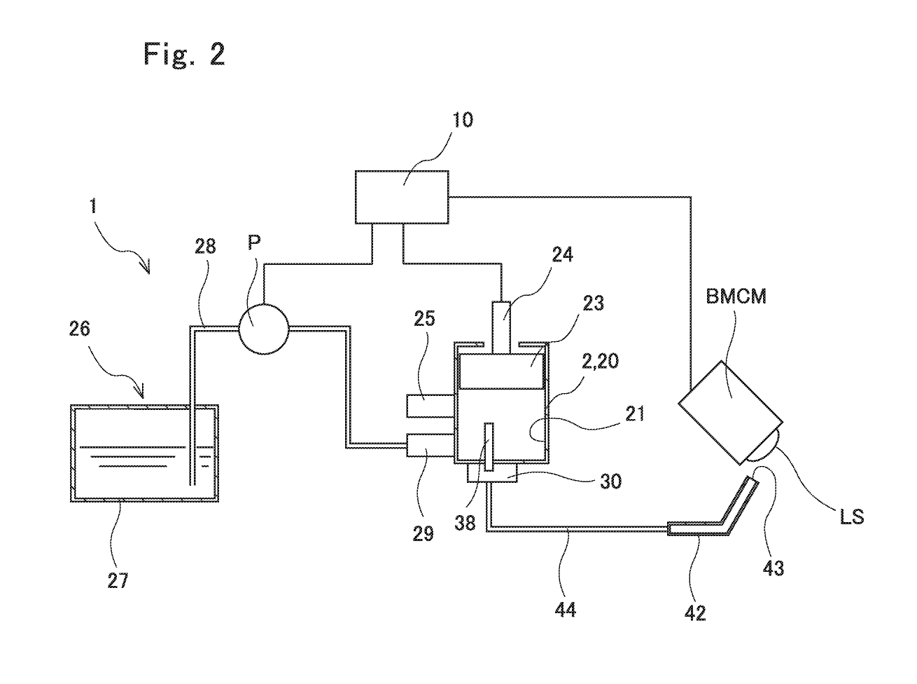

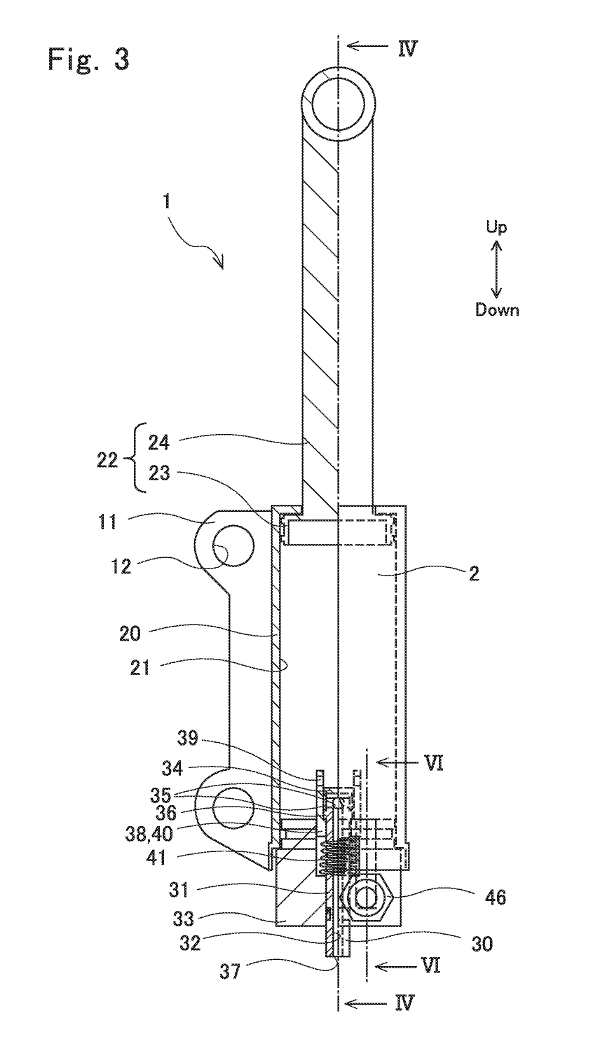

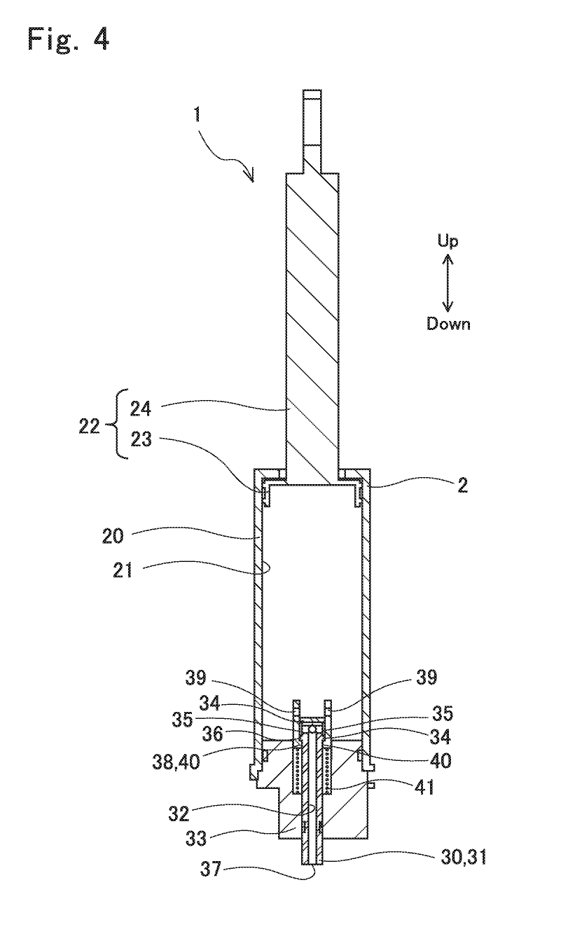

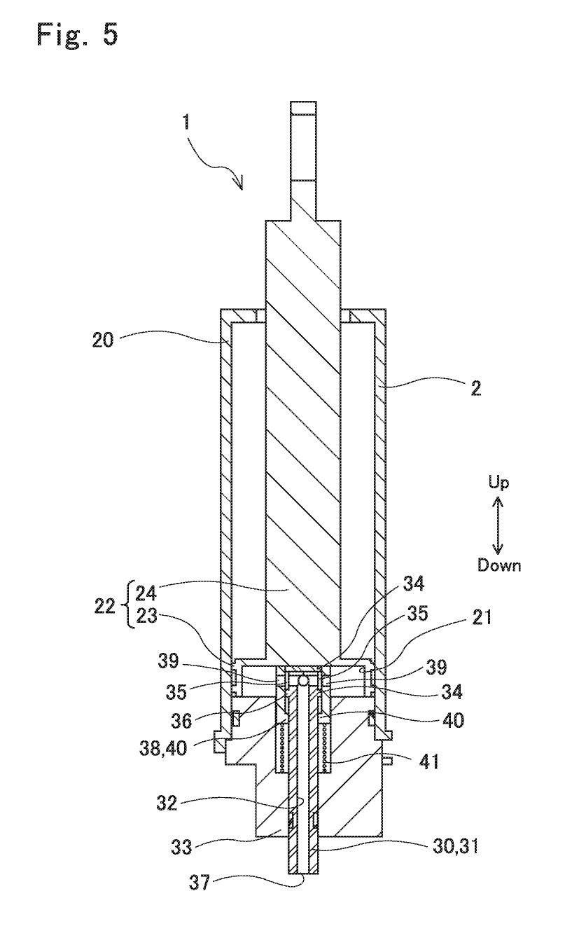

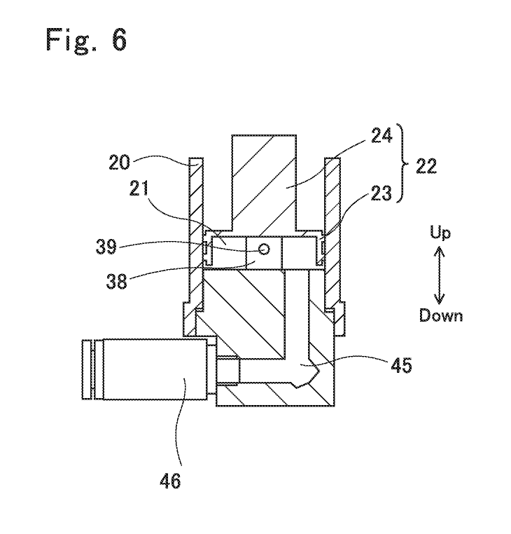

A washing device for on-board camera (hereinafter referred to as a “washing device 1”) according to First Embodiment of the present invention is constructed as shown in FIGS. 1 through 6. The present washing device 1 according to First Embodiment washes a lens surface “LS” of a back-monitoring camera “BMCM” for a vehicle “V.” FIG. 1 illustrates the vehicle “V” having the present washing device 1 on-board in a perspective view when viewed on the diagonally backward left side. FIG. 2 illustrates an overall construction of the present washing device 1 in a block diagram. FIG. 3 illustrates a construction of a tank 2 for the present washing device 1 in a partially-cross-sectional front view. FIG. 4 illustrates the present washing device 1 in a cross-sectional view when viewed in the direction of the arrows “IV”-“IV” shown in FIG. 3. FIG. 5 illustrates the present washing device 1, whose piston 2 shown in FIG. 4 is moved, in a cross-sectional view. FIG. 6 illustrates the present washing device 1 in a cross-sectional view when viewed in the direction of the arrows “VI”-“VI” shown in FIG. 3. As illustrated in FIG. 1, the present washing device 1 aims at the back-monitoring camera “BMCM” with which the vehicle “V” is equipped on the rear face. The back-monitoring camera “BMCM” shoots or makes a video of images of the rear of the vehicle “V.” The present washing device 1 deals with the back-monitoring camera “BMCM” that is arranged to face backward above a license plate attached to a vehicular rear face. The back-monitoring camera “BMCM” has the lens surface “LS” forming a surface (or an outer surface) which faces the outside of the vehicle “V.”

The present washing device 1 comprises a spout port 43, the tank 2, and a controller 10. The spout port 43, which is directed to the lens surface “LS,” spouts a washing liquid and compressed air. The tank 2 communicates with the spout port 43, and reserves the washing liquid and compressed air under pressurized condition. The controller 10 controls the washing liquid and compressed air reserved in the tank 2 so as to spout through the spout port 43.

As illustrated in FIGS. 2 through 5, the present washing device 1 according to First Embodiment further comprises a spout nozzle 42, and a washing-liquid supplier 26 (or a washing-liquid tank 27), in addition to the spout port 43, the tank 2 and controller 10. As illustrated in the drawings, the tank 2 includes a cylinder 20, and a piston 22. The tank 2 extends along the up/down direction (or the vertical direction). Instead of the tank 2 formed to extend along the up/down direction (or the vertical direction), the present washing device 1 also satisfactorily comprises the tank 2 formed to incline relative to the up/down direction (or the vertical direction) as far as the tank 2 allows reserving the washing liquid to be reserved in the interior under predetermined condition.

The cylinder 20 demarcates the outer circumference of a cylinder-shaped inner space 21. The cylinder 20 has a virtually cylindrical shape. The cylinder 20 has a downside end to which a nozzle 30 is fixed. The nozzle 30 thus demarcates the lower end of the inner space 21. The piston 22 includes a piston body 23, and a rod 24. The piston 22 is arranged inside the cylinder 20 reciprocably in the up/down direction while holding the interior of the cylinder 20 under liquid-tight and air-tight condition. As illustrated in FIGS. 4 and 5, the piston body 23 is arranged inside the inner space 21 reciprocably in the up/down direction. The piston body 23 has an outer circumferential face coinciding with a shape (or an inner circumferential shape) that the inner space 21 of the cylinder 20 has on the inner circumferential face. The piston body 23 thus demarcates the upper end of the inner space 21.

The rod 24 is made of a rod-shaped member whose lower end is fixed to the piston body 23. The rod 24 is connected with a not-shown presser at the upper end. The presser reciprocates the rod 24 in the up/down direction. The presser is not limited at all as far as it is capable of reciprocating the piston body 23 via the rod 24, namely, as far as it is capable of compressing the inner space 21.

The cylinder 20 is provided with a not-shown communication bore, which communicates the inner space 21 with the exterior of the tank 2, in the side wall. The communication bore is arranged on an upper side than a side on which a liquid level of the washing liquid reserved in the inner space 21 is located, specifically, a liquid level in the tank 2 reserving the washing liquid in a later-described predetermined volumetric amount. The communication bore is preferably arranged on a slightly upper side than a side on which the liquid level of the washing liquid is located. The communication bore is provided with a nonreturn valve 25. The nonreturn valve 25 admits the passage of air from the exterior of the tank 2 into the inner space 21, but inhibits the air from flowing from the inner space 21 to the exterior of the tank 2. The nonreturn valve 25 is arranged so as not to interfere with the piston 22 moving up and down.

The presser is connected electrically with the controller 10. The presser operates based on commands (or signals) from the controller 10. The controller 10 actuates the presser in accordance with commands (or input signals to switches, and the like) given by a driver, navigator or passenger of the vehicle “V.” Moreover, the controller 10 also satisfactorily issues a command for actuating the presser when it determines that foreign matters are present after it has judged whether or not foreign matters deposit on the lens surface “LS” from images that the camera “BMCM” shoots or make the video footage. In addition, the controller 10 even adequately issues the actuation command at predetermined intervals of time.

The controller 10, which is further connected electrically with a pump “P” of the washing-liquid supplier 26, instructs introducing the washing liquid from the washing-liquid tank 27 to the tank 2. As illustrated in FIG. 2, the washing-liquid supplier 26 includes a washing-liquid tank 27, a washing-liquid supply flow passage 28, the pump “P,” and a metering injector 29. The washing-liquid tank 27 reserves a large volumetric amount of the washing liquid in the interior. The washing-liquid tank 27 reserves the washing liquid in a volumetric amount much larger than the tank 2 reserves the washing liquid. The washing-liquid tank 27 is not limited at all in terms of its specific size (or capacity). The washing-liquid tank 27 preferably has a size (or capacity) which allows reserving the washing liquid in a volumetric amount that is required for repetitively washing the lens surface “LS” a few dozen times or more. When a window-washing liquid for the vehicle “V” involves the washing liquid, the washing-liquid tank 27 is also satisfactorily constructed so that it is shared by or combined with a tank for the window-washing liquid. Moreover, the washing liquid is even adequately constructed so that it is directly supplied from a tank for the window-washing liquid.

The washing-liquid supply flow passage 28 is arranged in such a manner as connecting the washing-liquid tank 27 with the tank 2. The washing-liquid supply flow passage 28 is formed of a pipe in which the washing liquid flows. The washing-liquid supply flow pas sage 28 is provided with the pump “P” at the middle in the route. The pump “P” transfers the washing liquid, which the washing-liquid tank 27 reserves, to the tank 2. The washing-liquid supply flow passage 28 is further provided with the metering injector 29 at the connection to the tank 2. The metering injector 29 adjusts a volumetric amount of the washing liquid, which the pump “P” supplies into the tank 2, to a predetermined volumetric amount determined in advance. It is not limited at all how the pump “P” and metering injector 29 are constructed specifically. The washing-liquid supplier 26 transfers the washing liquid, which the washing-liquid tank 27 reserves, to the metering injector 29 through the washing-liquid supply flow passage 28 using the pump “P.” The metering injector supplies the washing liquid into the tank 2 in the predetermined volumetric amount.

The nozzle 30 is fixed to the downside end of the cylinder 20. The nozzle 20 includes a nozzle body 31, and a valve 38. As illustrated in FIG. 3, the nozzle body 31 is made of a pipe-shaped, tube-shaped or cylinder-shaped member whose interior demarcates a communication passage 32. The nozzle body 31, whose upper end upper end protrudes into the inner space 21, is fixed air-tightly to the lower end of the cylinder 20 by a nozzle fixture 33. Moreover, the nozzle body 31 is arranged so that the upper end is located on a lower side than a side on which a liquid level of the washing liquid is located when the washing liquid is reserved in the tank 2. Note that the nozzle body 31 preferably includes later-described through bores 35 which are located lower than the liquid level of the washing liquid is located. In addition, a blocker 34 blocks an end face that the nozzle body 31 has at the pipe-shaped upper end. The blocker 34 makes a flat plate shape parallel to the flat face (or horizontal face) that the nozzle body 31 has in the direction perpendicular to the axis.

Moreover, the nozzle body 31 is provided with the through bores 35, which penetrate the nozzle body 31 diametrically, at the upper end. The through bores 35 are formed in part of the nozzle body 31 which protrudes into the inner space 21. At the upper end of the nozzle body 31, the through bores 35 communicate the pipe-shaped interior with the exterior. The through bores 35 are not limited at all in terms of the quantity and diameter. For example, the present washing device 1 according to First Embodiment has the through bores 38 in a quantity of four disposed at equal intervals in the circumferential direction. The nozzle body 31 is further provided with an annular protuberance 36 on the outer circumferential face that is present at around the upper end but is located on a lower side than a side on which the through bores 35 are located. The protuberance 36 is formed in part of the nozzle body 31 which protrudes into the inner space 21.

The nozzle body 31 is connected with the spout nozzle 42 at the lower end 37. The nozzle body 31 and spout nozzle 42 connect with one another via a connector pipe 44. As illustrated in FIG. 2, the spout nozzle 42 is made of a pipe-shaped member having opposite ends one of which is connected with the connector pipe 44, and another one of which makes the spout port 43. The spout nozzle 42 is made to admit the washing liquid through one of the opposite ends connected with the connector pipe 44, and to spout the washing liquid through another one of the opposite ends making the spout port 43. The spout port 43 is directed to the lens surface “LS” of the camera “BMCM” in the vehicle “V.” The washing liquid spouting through the spout port 43 is blown to the lens surface “LS.”

As illustrated in FIGS. 3 through 5, the nozzle body 31 has the upper end arranged inside the valve 38. The valve 38 is made reciprocable in the up/down direction (or in the axial direction). The valve 38 has a cylindrical shape with an interior into which the upper end of the nozzle body 31 is inserted. The valve 38 is provided with through bores 39, which penetrate the valve 38 diametrically, in the upper wall. The through bores 39 are not limited at all in terms of the quantity and diameter. For example, the present washing device 1 according to First Embodiment has the through bores 39 in a quantity of four. The four through bores 39 are formed at locations corresponding to those of the through bores 35 formed in the valve body 31, namely, at circumferentially symmetric locations to each other. The through bores 39 of the valve 38 are formed so that: they communicate with the through bores 35 of the nozzle body 31 when the valve 38 has shifted toward the lower end of the nozzle body 31, specifically when the valve 38 has shifted to the lowermost end position as shown in FIG. 5; and they are closed down by the side wall of the nozzle body 31 when the valve 38 has shifted from the lowermost end position toward the upper end of the nozzle body 31. Note that the through bores 39 of the valve 38 are located on a more upper side than a side on which the blocker 34 of the nozzle body 31 is located when the valve 38 has shifted to the uppermost position as shown in FIGS. 3 and 4.

The valve 38 includes an annular flange 40, which protrudes inward diametrically, at the lower end. As illustrated in FIG. 3, the flange 40 has an upper face making a flat face which closely adheres to the lower face of the annular protuberance 36 on the nozzle body 31. The upper face of the flange 40, and the lower face of the annular protuberance 36 on the nozzle body 31 closely adhere to one another air-tightly. The flange 40 has an inner circumferential face formed so as to closely adhere to an outer circumferential face of the nozzle body 31. The inner circumferential face of the flange 40, and the outer circumferential face of the nozzle body 31 maintain the close adherence even when the valve 38 moves up and down. That is, the valve 38 and nozzle body 31 keep the air tightness and liquid tightness between them.

A spring 41, which is arranged on a lower side of the valve 38, presses the valve 38 upward. That is, the spring 41 urges the valve 38 to the nozzle body 31 so that the upper face of the flange 40 and the lower face of the annular protuberance 36 on the nozzle body 31 adhere closely one another.

The spring 41, which is made of a coil spring with the pipe-shaped nozzle body 31 arranged at the axial center, presses the flange 40 upward. The spring 41 accordingly presses the valve 38 upward. Although the present washing device 1 according to First Embodiment uses a coil spring as the spring 41, it satisfactorily allows using elastic bodies other than the coil spring, or actuators.

The piston 22 presses the valve 38 downward. As the valve 38 is shifted downward, the through bores 39, with which the valve 38 is provided in the side wall, are also shifted downward positionally. As a result, the through holes 39 are shifted to a position at which they overlap the through bores 35. The through bores 39 in the valve 38 communicate with the through bores 35 in the nozzle body 31, communicating the inner space 21 with the communication passage 32. That is, the inner space 21 communicates with the spout nozzle 42 via the communication passage 32. In other words, the overlapped through bores 39 and through bores 35 permit the washing liquid and compressed air to flow inside the valve body 31. In addition to the communication passage 32 in the nozzle body 31, the nozzle 30 further includes another flow passage 45 (shown in FIG. 6) serving as a route for introducing the washing liquid into the tank 2. The flow passage 45 is connected with the metering injector 29 of the washing-liquid supplier 26. As illustrated in FIG. 6, the nozzle 30 is provided with the flow passage 45 in which the washing liquid coming from the metering injector 29 of the washing-liquid supplier 26 flows.

The flow passage 45 opens in the inner space 21 at one of the opposite ends. As illustrated in FIGS. 3 through 5, the present washing device 1 according to First Embodiment further comprises a nozzle fixture 33 in which the flow passage 45 is demarcated. As illustrated in FIG. 6, the flow passage 45 is provided with a check valve 46 at another one of the opposite ends. The check valve 46 is connected with the washing-liquid supplier 26, controlling the flow of the washing liquid coming from the washing-liquid tank 27. The check valve 46 permits the washing liquid to flow inside the flow passage 45 toward the inner space 21, but inhibits the washing liquid from flowing backwardly to the permitted flow.

The present washing device 1 according to First Embodiment is not limited at all in terms of the volumetric size of the uncompressed inner space 21. However, the uncompressed inner space 21 preferably has a volume of from 20 to 80 mL, more preferably from 20 to 60 mL, for instance. Moreover, the magnitude of a specific pressure in the compressed inner space 21 is not limited at all, either. However, the compressed inner space 21 satisfactorily exhibits an ordinary pressure (i.e., 101,325 Pa (or about 0.1 MPa (or 1 atm))) or more, or preferably exhibits a pressure of 202, 650 Pa (or about 0.2 MPa (or 2 atm)) or more, for instance. In addition, the ratio of the uncompressed inner space 21 to the compressed inner space 21 is preferably twofold or more, more preferably threefold or more.

### Operations of First Embodiment

As illustrated in FIGS. 1 and 2, the present washing device 1 according to First Embodiment is installed on a rear face of the vehicle “V.” The present washing device 1 comprises the spout port 43 directed to the lens surface “LS” of the back-monitoring camera “BMCM.” As illustrated in FIG. 3, the cylinder 20 of the tank 2 is provided with a plate-shaped tab 11 in which screwed holes 12 open. Not-shown bolts or clips are pierced through the screwed holes 12 to fasten or fix the present washing device 1 to the vehicle “V, ” installing the present washing device 1 on the rear face of the vehicle

A driver, navigator or passenger of the vehicle “V” judges whether or not foreign matters deposit on the lens surface “LS” of the on-board back-monitoring camera “BMCM” for the vehicle “V” from images that the back-monitor camera “BMCM” shoots or makes a video of. Then, the driver, navigator or passenger operates a switch for the present washing device 1 according to First Embodiment when he or she determines that foreign matters have deposited on the lens face “LS.”

The controller 10, which has received a signal that the switch is manipulated, actuates the presser to retain the piston 22 at the uppermost end position, namely, put it under the condition that it is located on the uppermost side as shown in FIG. 3. On this occasion, the inner space 21 reserves the washing liquid and air, which exhibits an ordinary pressure approximately, in a predetermined volumetric amount, respectively.

In contrast, when the piston 22 is not present at the uppermost end, for instance, when it is located at the lowermost end as shown in FIG. 5, the presser actuates the piston 22 to move it to the position at the uppermost end. As the piston 22 moves to the upper end side, the spring 41 pushes the valve 38 upward, shifting the valve 38 to the upper side. Moreover, as the valve 38 further shifts to the upper side, the upper face in the flange 40 comes in contact with the lower face in the annular protuberance 36 on the nozzle body 31, adhering to one another as shown in FIG. 3. That is, the valve 38 shifts up to the position at the uppermost end. The valve 38 retains the position at the uppermost end air-tightly and liquid-tightly, because the spring 41 urges the valve 38 upward. Under the circumstances, the four through bores 39 in the valve 30 do not communicate with the four through bores 35 in the nozzle body 31, because the through bores 39 are located on a more upper side than a side on which the through bores 35 are located. At the same time, the side wall of the valve 38 closes down the opening of the through bores 35.

Then, as the piston 22 further moves upward, air is suctioned through the communication bore opening in the side wall of the tank 2 and the nonreturn valve 25, and is then introduced into the inner space 21, because the inner space 21 expands to be depressurized. Subsequently, the controller 10 issues a command so as to introduce the washing liquid into the inner space 21 from the washing-liquid tank 27. Specifically, the controller 10 actuates the pump “P” to flow the washing liquid into the washing-liquid supply flow passage 28 from the washing-liquid tank 27. The washing liquid is supplied to the metering injector 29 after it has flowed inside the washing-liquid supply flow passage 28. The metering injector 29 introduces the washing liquid into the inner space 21 in a predetermined volumetric amount that has been determined in advance.

Under the condition that the presser retains the piston 22 at the uppermost end position, the spring 41 urges the valve 38 upward. Under the circumstances, the washing liquid and air, which are held in the tank 2, are not discharged to the outside through the communication passage 32 and spout port 43, because the upper face in the flange 40 adheres to the lower face in the annular protuberance 36 on the nozzle body 31 air-tightly and liquid-tightly. Moreover, the communication bore is provided with the nonreturn valve 25, and the nozzle 30 is provided with the check valve 46 connected with the metering injector 29. The nonreturn valve 25 and check valve 46 inhibit the washing liquid and ordinary-pressure air, which have been introduced into the inner space 21, from flowing backward from the inner space 21 to the exterior of the tank 2 through the communication bore and flow passage 45, allowing the inner space 21 to reserve the washing liquid and ordinary-pressure air. On this occasion, the washing liquid occupies the lower side within the inner space 21, whereas the air occupies the upper side. Moreover, the washing liquid has a liquid level located more upward than the through bores 35 of the nozzle body 31 are located. The present washing device 1 according to First Embodiment comprises the inner space 21 having a volumetric capacity of 60 mL when the piston 22 retains the position at the uppermost end. For example, the inner space 21 holds the washing liquid and ordinary-pressure air introduced into the interior in a volumetric amount of from 2 to 3 mL, respectively.

Subsequently, the controller 10 actuates the presser to move the piston body 23, namely, the piston 22, via the rod 24. Thus, the inner space 21 decreases in the volumetric capacity, compressing the air, namely, turning the air into compressed air. Under the circumstances, the tank 2 reserves the washing liquid and compressed air which are pressurized.

Moreover, as the piston body 23 moves downward, the lower face of the piston body 23 comes in contact with the upper end of the valve 38. As the piston body 23 moves further downward, the piston body 23 presses the valve 38 downward. As the valve 38 is pressed to a lower side, the through bores 39, with which the valve 38 is provided in the side wall, shift downward. As the valve 38 is pressed to shift the through bores 39 downward, the through bores 39 in the valve 38 overlap the through bores 35 in the nozzle body 31. The overlapped through bores (35, 39) communicate the inner space 21 with the communication passage 32. On this occasion, the present washing device 1 according to First Embodiment comprises the piston body 23 moved so as to change the volumetric capacity of the inner space 21 from the original 60 mL to 20 mL, namely, by a compression ratio of 3 (or 3:1). Thus, the air is pressurized from 0.1 MPa (or 1 atm) to 0.3 MPa (or 3 atm).

When the inner space 21 communicates with the communication passage 32, the washing liquid and air (or compressed air) reserved in the inner space 21 pass through the communication passage 32 and connector pipe 44 and then spout from out of the spout port 43. Note herein that the pressure of the compressed air pushes out the washing liquid so that the washing liquid spouts through the spout port 43 with greater momentum, because the washing liquid occupies a lower side and the air occupies an upper side within the inner space 21.

The washing liquid, which spouts through the spout port 43, blows onto the lens surface “LS” of the back-monitoring camera “BMCM” arranged against the spout port 43. The washing liquid blows off foreign matters deposited on the lens surface “LS” with the blowing pressure, removing the foreign matters from the lens surface “LS.” After the washing liquid has spouted, the air (or compressed air), which is present above the washing liquid within the inner space 21, spouts through the spout port 43. The air, which spouts through the spout port 43, blows onto the lens surface “LS.” The thus spouting air blows off droplets of the washing liquid which have been left on the lens surface “LS.” As described above, the present washing device 1 according to First Embodiment blows off foreign matters deposited on the lens surface “LS,” removing the foreign matters, namely, washing the lens surface “LS.”

### Advantageous Effects of First Embodiment

The present washing device 1 according to First Embodiment comprises the spout port 43, the tank 2, and the controller 10. The spout port 43 is directed the lens face “LS” of the back-monitoring camera “BMCM” which the vehicle “V” has on-board, and spouts the washing liquid and compressed air. The tank 2 communicates with the spout port 43, and reserves the washing liquid and compressed air under pressurized condition. The controller 10 controls the washing liquid and compressed air reserved in the tank 2 so as to spout through the spout port 43.

The present washing device 1 according to First Embodiment carries out the following operations using the controller 10 which controls the other constituent elements. First of all, the present washing device 1 compresses the air and washing liquid at the tank 2. That is, the tank 2 reserves the washing liquid and compressed air under pressurized condition in the inner space 21. Then, the present washing device 1 spouts the pressurized washing liquid and compressed air through the spout port 43, blowing them onto the lens surface “LS.” Specifically, the present washing device 1 spouts the washing liquid through the spout port 43 with the pressure of the compressed air. The washing liquid, which spouts through the spout port 43, blows onto the lens surface “LS,” because the spout port 43 is directed to the lens surface “LS.” The washing liquid, which spouts through the spout port 43, hits with greater momentum against foreign matters deposited on the lens surface “LS.” Thus, the present washing device 1 blows off foreign matters deposited on the lens surface “LS,” allowing getting rid of the foreign matters. In particular, the present washing device 1 permits removing the foreign matters more effectively, because the strong pressure of the compressed air impinges the washing liquid on the foreign matters. Accordingly, the present washing device 1 allows decreasing a blowing amount of the washing liquid per washing operation more than that in dripping the washing liquid onto the lens surface “LS,” and more than that in blowing the misted washing liquid onto it. Consequently, the present washing device 1 permits demonstrating the high washing performance while inhibiting the used amount of the washing liquid from increasing.

The present washing device 1 according to First Embodiment comprises the nozzle 30 controlling the distribution of the washing liquid and compressed air which flow through the communication passage 32 and connector pipe 44 communicating the tank 2 with the spout port 43. The nozzle 30 includes the nozzle body 31, and the valve 38 with which the nozzle body 31 is provided at the upper end. The nozzle body 30 has the upper end that is located on a lower side than a side on which a liquid level of the reserved washing liquid is located. The nozzle body 31 and valve 38 are provided with the through bores 35 and through bores 39 in a quantity of four, respectively. When the four paired through bores (38, 39) overlap with each other, they communicate with the communication passage 32 to forma flow passage in which the washing liquid flows. On the side of the tank 2, the resulting flow passage has an end that is formed by the through bores 39, and which opens at a lower side than a side at which a liquid level of the washing liquid reserved in the tank 2 is present.

The thus constructed present washing device 1 according to First Embodiment enables the washing liquid and compressed air held in the tank 2, specifically, within the inner space 21 in the tank 2, to spout through the spout port 43 via the communication passage 32 by controlling the valve 38. Moreover, when the valve 38 is opened, the pressure of the compressed air makes the washing liquid pass through the communication passage 32 prior to the compressed air, because the opening of the communication passage 32 is located more below than the liquid level of the reserved washing liquid is located. Thus, the compressed air, which presses the washing liquid, allows the washing liquid to reliably pass through the communication passage 32. That is, the present washing device 1 permits the spout port 43 to reliably spout the washing liquid.

The thus constructed present washing device 1 according to First Embodiment spouts the compressed air after spouting the washing liquid. The present washing device 1 uses the compressed air, which spouts through the spouting port 43 after the washing liquid, to blow off liquid droplets deposited on the lens surface “LS.” As a result, the present washing device 1 allows demonstrating the high washing performance in a more enhanced manner.

The present washing device 1 according to First Embodiment comprises the tank 2 including the cylinder 20, and the piston 22 moving inside the cylinder 20. The thus constructed present washing device 1 allows increasing the pressure in the cylinder 20 by moving the piston 22 downward. That is, the present washing device 1 permits producing the compressing air readily. In other words, the piston 2, which is moved from the upper end to a lower side, decreases the volumetric capacity of the inner space 21 in the tank 2, compressing the air in the inner space 21. Under the circumstances, the washing liquid and compressed air are reserved within the tank 2 under pressurized condition.

### Second Embodiment

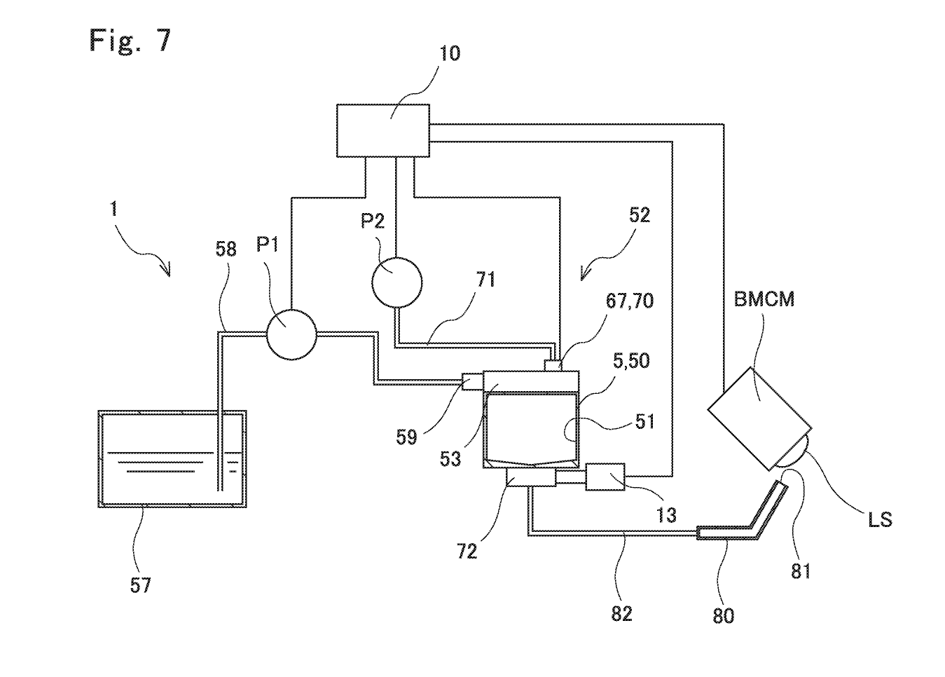

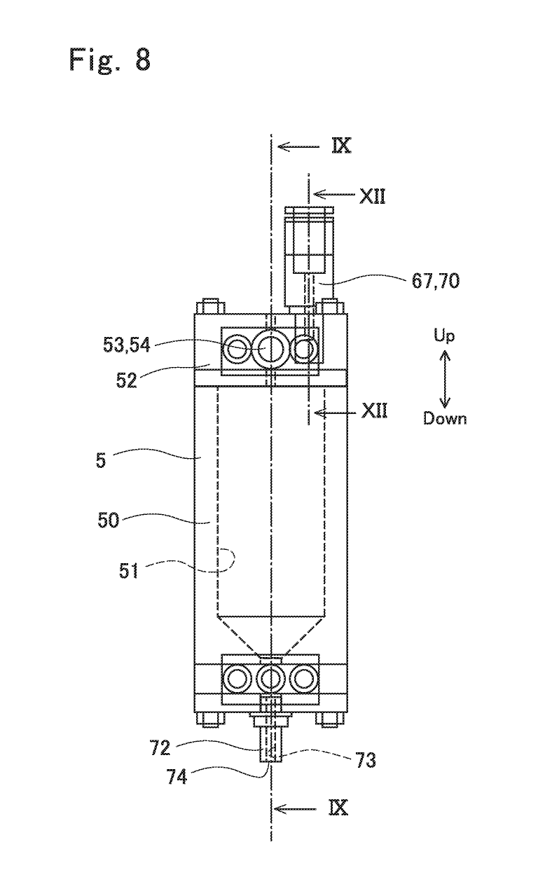

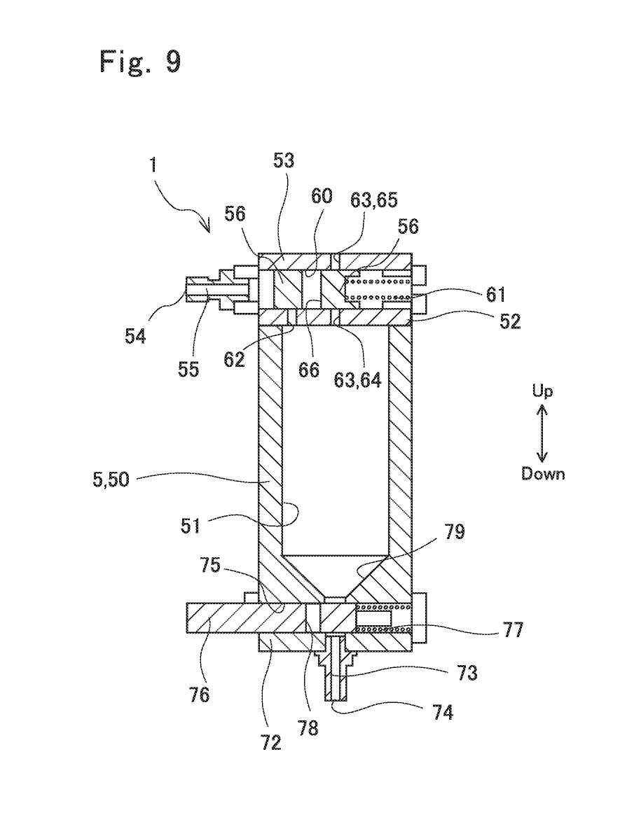

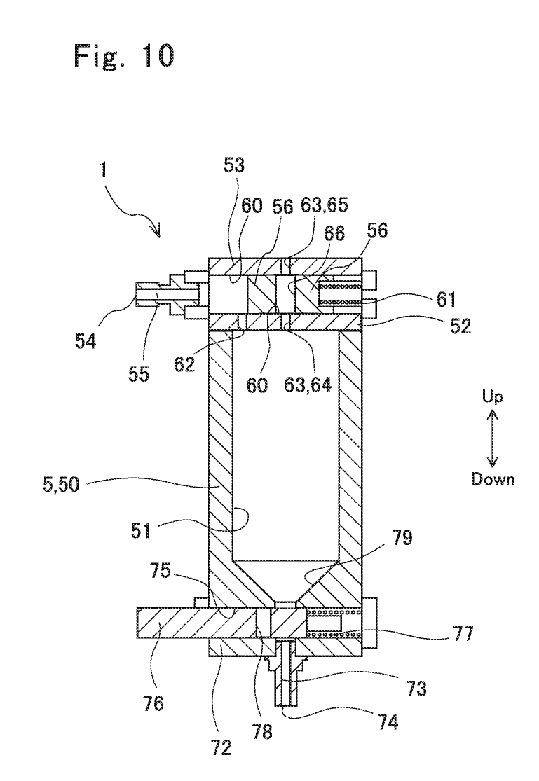

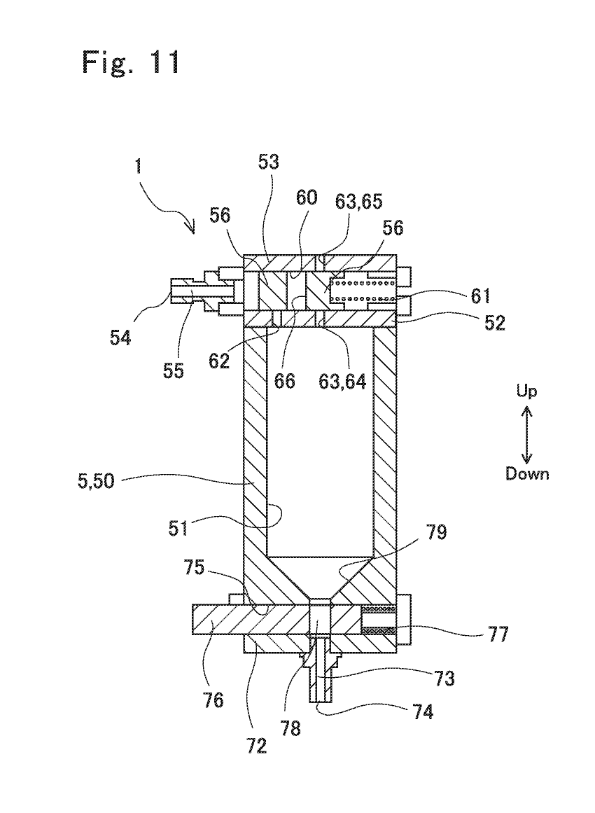

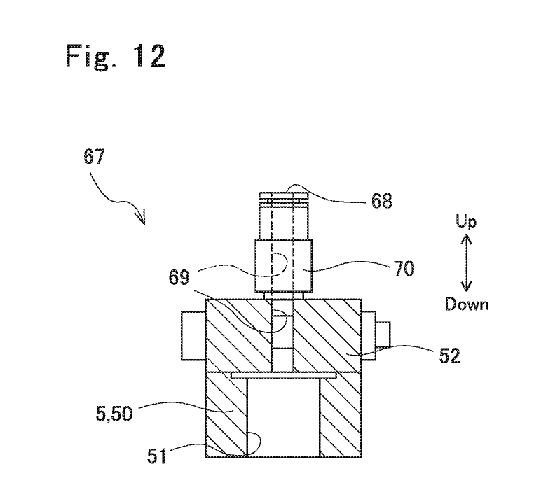

A washing device 1 for on-board camera according to Second Embodiment of the present invention is constructed as shown in FIGS. 7 through 12. Unless especially referred to otherwise, the present washing device 1 according to Second Embodiment comprises the same constituents as those of First Embodiment. FIG. 7 illustrates an overall construction of the present washing device 1 in a block diagram. FIG. 8 illustrates the present washing device 1 in a front view. FIG. 9 illustrates the present washing device 1 in a cross-sectional view when viewed in the direction of the arrows “IX”-“IX” shown in FIG. 8. FIG. 10 illustrates the present washing device 1 in a cross-sectional view, wherein the valve of a washing-fluid introducer shown in FIG. 9 is moved. FIG. 11 illustrates the present washing device 1 in a cross-sectional view, wherein the valve of a nozzle shown in FIG. 9 is moved. FIG. 12 illustrates the present washing device 1 in a cross-sectional view when viewed in the direction of the arrows “XII”-“XII” shown in FIG. 8. As illustrated in the drawings, the present washing device 1 comprises a tank 5, a spout nozzle 80, a washing-liquid tank 57, and a controller 10.

As illustrated in FIGS. 7 through 11, the tank 2 includes a cylinder 50, and a washing-fluid introducer 52. The tank 5 extends along the up/down direction (or the vertical direction). The cylinder 50 demarcates the outer circumference of a cylindrical inner space 51. The cylinder has a substantially-circular columnar shape. The cylinder 50 has a lower-side opposite end to which a nozzle 72 is fixed. The nozzle 72 demarcates the lower opposite end of the inner space 51. To the upper opposite end of the cylinder 50, the washing-fluid introducer 52 is fixed as shown in FIGS. 8 through 12. The washing-fluid introducer 52 demarcates the upper opposite end of the inner space 51. The washing-fluid introducer 52 includes a washing-liquid flow-in section 53 into which the washing liquid flows in, and a compressed-air flow-in section 67 into which the compressed air flows in.

As illustrated in FIGS. 8 through 11, the washing-liquid flow-in section 53 includes a flow-in port 54, and a flow passage 55. The washing liquid flows into the flow-in port 54. The flow pas sage 55, in which the washing liquid flows, communicates the flow-in port 54 with the inner space 51. The flow passage 55 is provided with a valve 56 in the interior. The valve 56 controls the flow of the washing liquid flowing through the flow passage 55.

The flow-in port 54 opens in an outer circumferential face of the cylinder 50 of the tank 5. The flow-in port 54 is formed of a connector connecting the washing-liquid flow-in section 53 with the external washing-liquid tank 57. The flow-in port 54 makes an opposite end on one of the sides of the flow passage 55. The flow passage 55 opens in the inner space 51 within the tank 5 at another opposite end on the other side facing the inner space 51.

As illustrated in FIG. 7, the washing-liquid flow-in section 53 is connected with the washing-liquid tank 57 via a washing-liquid supply flow passage 58, a pump “P1” and a metering injector 59. The washing-liquid tank 57, washing-liquid supply flow passage 58, pump “P1” and metering injector 59 are constructed in the same manner as the washing-liquid tank 27, washing-liquid supply flow passage 28, pump “P” and metering injector 29 according to First Embodiment.

As illustrated in FIGS. 9 and 11, the valve 56 is accommodated inside a valve accommodation space 60 demarcated so as to elongate along the right/left direction in the drawings, or in the perpendicular direction to the up/down direction. The valve 56 is arranged reciprocably inside the valve accommodation space 60 in the horizontal direction, or in the right/left direction in the drawings. A spring 61 is arranged inside the valve accommodation space 60 at an end on one of the opposite sides across from the other opposite side on which the flow-in port 54 is arranged. The spring 61 is arranged about the center of the valve 56 on the opposite side across from the flow-in port 54. The spring 61 presses the valve 56 toward the flow-in port 54. A not-shown inhibitor inhibits the valve 56 from shifting toward the flow-in port 54 in a predetermined magnitude or more. As illustrated in FIG. 9, the spring 61 always urges the valve 56 toward the flow-in port 54.

The valve 56 shifts because it is pressed by the pressure of the washing liquid flowing into the valve accommodation space 60 through the flow-in port 54. Specifically, when the pressure of the washing liquid flowing into the valve accommodation space 60 overcomes the pressing force of the spring 61, the pressure of the washing liquid shifts the valve 56 in the direction of compressing the spring 61. When the washing liquid stops flowing into the valve accommodation space 60 through the flow-in port 54, the pressing force of the spring 61 returns the valve 56 to a position where the valve 56 gets closest to the flow-in port 54. The present washing device 1 according to Second Embodiment comprises the valve 56 shifted by the pressure of the washing liquid. However, the present washing device 1 is not limited to the valve 56 thus constructed. That is, in order to shift the valve 56, a not-shown presser or actuator is also satisfactorily connected with the valve 56. In this instance, the presser or actuator reciprocates the valve 56 inside the valve accommodation space 60.

The washing-liquid flow-in section 53 is provided with a through bore 62 communicating the upper end of the inner space 51 with the valve accommodation space 60. The through bore 62 elongates in the up/down direction. The through bore 62 is formed at a position where it is closed down by the valve 56 under the condition that the spring 61 shifts the valve 56 to a position closest to the side of the flow-in port 54. The valve 56 comes not to close down the through bore 62 because the through bore 62 is exposed within the valve accommodation space 60, as shown in FIG. 10, under the other condition that the valve 56 has shifted from the position closest to the side of the flow-in port 54, namely, under the condition that the pressure of the washing liquid presses the valve 56 to shift. The valve accommodation space 60 and through bore 62 thus communicating with one another links the flow-in port 54 to the inner space 51, forming the flow passage 55 in which the washing liquid flows. Moreover, the washing-liquid flow-in section 53 further includes an exhaust flow passage 63 for exhausting the inner space 51 at the time of introducing or replenishing the washing liquid into the inner space 51.

As illustrated in FIGS. 9 and 10, the washing-liquid flow-in section 53 is provided with a first exhaust through bore 64 communicating the upper end of the inner space 51 with the valve accommodation space 60. The first exhaust bore 64 opens at a position that is separated more away from the flow-in port 54 than that at which the through bore 62 is present. Specifically, FIG. 9illustrates the first exhaust through bore 64 formed on the right side of the through bore 62. Moreover, a second exhaust through bore 65, which communicates the valve accommodation space 60 with the outside of the present washing device 1 according to Second Embodiment, is formed above the first exhaust bore 64. The second exhaust through bore 65 opens in the upper end (or upper face) of the tank 5 of the present washing device 1. The first exhaust through bore 64 and second exhaust through bore 65 are formed at positions where they are coaxial with one another.

The valve 56 is provided with a third exhaust through bore 66 capable of communicating with the first exhaust through bore 64 and second exhaust through bore 65. As the valve 56 shifts, the third exhaust through bore 66 communicates with the first exhaust through bore 64 and second exhaust through bore 65 as shown in FIG. 10. Thus, an exhaust flow passage 63, which is made up of the first exhaust through bore 64, second exhaust through bore 65 and third exhaust through bore 66, is formed.

The third exhaust through bore 66 formed in the valve 56 neither communicates with the first exhaust through bore 64 nor the second exhaust through bore 65 under the condition that the valve 56 shifts closest to the side of the flow-in port 54 as shown in FIGS. 9 and 11. In contrast, the third exhaust through bore 66 is present at a position where it communicates with the first exhaust through bore 64 and second exhaust through 65 under the other condition that the valve 56 has shifted from the side closest to the flow-in port 54, namely, under the condition that the valve 56 detaches itself from the flow-in port 54 as shown in FIG. 10.

The valve 56 closes down the first exhaust through bore 64 and second exhaust through bore 65 under the condition that the spring 61 urges the valve 56 to shift to the side closest to the flow-in port 54 as shown in FIGS. 9 and 10. In contrast, the valve 56 communicates between the first exhaust through bore 64, the second exhaust through bore 65 and the third exhaust through bore 66 under the other condition that the valve 56 has shifted from the side closest to the flow-in port 54 as shown in FIG. 10.

As illustrated in FIG. 12, the compressed-air flow-in section 67 includes a compressed-air flow-in port 68, and a compressed-air flow passage 69. The compressed air flows in through the compressed-air flow-in port 68. The compressed-air flow passage 69, in which the compressed air flows, connects the compressed-air flow-in port 68 with the inner space 51. The compressed air flow-in section 67 further includes a valve 70. The valve 70, which is arranged inside the compressed-air flow passage 69, controls the compressed air flowing in the compressed-air flow passage 69.

The compressed-air flow-in port 68 opens in the upper end (or upper face) of the present washing device 1 according to Second Embodiment in a manner directed upward. The compressed-air flow-in port 68 is connected with a gas source. The gas source, which is arranged outside the tank 5, supplies the compressed air to the tank 5. A connector connectable with the gas source forms the compressed-air flow-in port 68. The gas source is not limited at all as far as it allows supplying the compressed air to the tank 5 of the present washing device 1. However, exemplifiable gas sources are pressurizer pumps (or compressors), and accumulator bombs (or gas bombs). The present washing device uses a pressurizer pump “P2” as the gas source. As illustrated in FIG. 7, the pressurizer pump “P2” compressing external air is connected with the compressed-air flow-in port 68 via a compressed-air supply flow passage 71 made of piping. The pressure of the compressed air, which the pressurizer pump “P2” supplies, is not limited at all. However, the pressure of the compressed air is satisfactorily equivalent to that of the air compressed in accordance with First Embodiment.

As illustrated in FIG. 12, the valve 70 is arranged on the side of the compressed-air flow-in port 68 in the compressed-air flow passage 69. The valve 70 is made of a control valve, namely, a non return valve inhibiting back-flow, which controls a flow volume of the compressed air flowing from the pressurizer pump “P2” to the inner space 51 through the compressed-airflow-in port 58. The valve 70 is connected electrically with the controller 10, is operated in accordance with instructions or commands from the controller 10.

As illustrated in FIGS. 8 through 11, the nozzle 72 is fixed to the lower-side end of the cylinder 50. The nozzle 72 is made of a pipe-shaped (or cylindrical) member demarcating a communication passage 73 which communicates the inner space 51 with a spout port 81.

The nozzle 72 demarcates a valve accommodation space 75 at the upper end, namely, at the connection between the nozzle 72 and the inner space 51. The valve accommodation space 75 expands along a direction perpendicular to the up/down direction, namely, in the right/left direction in FIGS. 9 through 11 (or in a direction substantially parallel to the valve accommodation space 60). The valve accommodation space 75 accommodates a valve 76. The valve 76 is arranged reciprocably inside the valve accommodation space 75. In the same manner as the spring 61 presses the valve 56, a spring 77 presses the valve 76, urging the valve 76 to put the nozzle 72 under the close-down condition, namely, to put the nozzle 72 under the condition of inhibiting the washing liquid from flowing.

As illustrated in FIG. 9 through 11, the spring 77 presses the valve 76 toward the left side in the drawings. A not-shown inhibitor inhibits the valve 76 from shifting in a pre determined magnitude or more. As illustrated in FIGS. 8 and 9, the spring 77 always urges the valve 76. That is, the inhibitor holds the valve 76 under the condition of being inhibited from shifting any further, namely, under the condition of closing the nozzle 72. The valve 76 is connected with a presser 13 as shown in FIG. 7. The presser 13 reciprocates the valve 76 inside the valve accommodation space 75. The presser 13 is connected electrically with the controller 10. The presser 13 operates in accordance with commands from the controller 10.

As illustrated in FIGS. 9 through 11, the valve 76 is provided with a through bore 78 elongating in the up/down direction. The through bore 78 is made at a position in the valve 76 where it does not overlap the communication passage 73 under the condition that the valve 76 has shifted to the farthest left side in the drawings, namely, under the condition that the inhibitor inhibits the valve 76 from shifting any further as shown in FIGS. 9 and 10; but the through bore 78 overlaps the communication passage 73 under the other condition that the valve 76 has shifted from the position at which it is present on the farthest left side as shown in FIGS. 9 and 10 to the right side as shown in FIG. 11.

As illustrated in FIGS. 8 through 11, the present washing device 1 according to Second Embodiment comprises the inner space 51 demarcated in the cylinder 50, and having a downside end which is formed as an inclination face 79 for guiding the washing liquid to the communication passage 73.

The nozzle 72 has a lower end 74 connected with the a spout nozzle 80 via a connector pipe 82 as shown in FIG. 7. As illustrated in the drawing, the spout nozzle 80 is made of a pipe-shaped member one of whose opposite ends is connected with the connector pipe 82, and another one of whose opposite ends makes the spout port 81. The spout port 81 is directed to the lens surface “LS” of the back-monitoring camera “BMCM” on-board the vehicle “V.” The washing liquid spouting through the spout port 81 is blown onto the lens surface “LS.”

### Operations of Second Embodiment

How the present washing device 1 according to Second Embodiment operates will be hereinafter described in the same manner as the operations of First Embodiment. In operating the present washing device 1, a driver, navigator or passenger of the vehicle “V” judges whether or not foreign matters deposit on the lens surface “LS” of the back-monitoring camera “BMCM” in the same manner as First Embodiment. When the driver, navigator or passenger determines that foreign matters deposit on the lens surface “LS,” he or she operates a not-shown switch for the present washing device 1. The controller 10, which has received a signal from the operated switch, commands the presser 13 to hold the nozzle 72 under the condition that the valve 76 closes the nozzle 72, namely, under the condition that the spring 77 (i.e., the inhibitor) presses the valve 76 to inhibit it from shifting. In contrast, the controller 10 operates the presser 13 to close down the nozzle 72 when the nozzle 72 is opened, namely, when the spring 77 (i.e., the inhibitor) does not inhibit the valve 76 from shifting.

Subsequently, the washing liquid is introduced into the inner space 51 using the washing-liquid flow-in section 53 of the washing-fluid introducer 52. Specifically, the controller 10 actuates the pump “P1,” flowing the washing liquid in the washing-liquid tank 57 to the metering injector 59 via the washing-liquid supply flow passage 58. The washing liquid supplied to the metering injector 59 is introduced into the flow-in port 54 in a predetermined volumetric amount that has been set up in the metering injector 59 in advance. The washing liquid introduced into the flow-in port 54 presses the valve 56. The valve 56 pushed by the washing liquid shifts in the direction of separating away from the flow-in port 54, exposing the through bore 62 within the inner space 51 as shown in FIG. 10. The flow-in port 54, the valve accommodation space 60, and the through bore 62 form the flow passage 55 in which the washing liquid flows. The washing liquid flowing in the flow passage 55 eventually flows into the inner space 51.

Simultaneously with the shifting of the valve 56 in the direction of separating away from the flow-in port 54, the first exhaust through bore 64, the second exhaust through bore 65, and the third exhaust through bore 66 communicate with each other. That is, the first exhaust through bore 64, second exhaust through bore 65 and third exhaust through bore 66 form the exhaust flow passage 66. The thus formed exhaust flow passage 66 keeps the pressure within the inner space 51 from rising, namely, keeps the inner pressure from rising, when the washing liquid finished flowing in the flow passage 55 flows into the inner space 51. As a result, the washing liquid is introduced into the inner space 51 without the help of compression transportation.

The controller 10 stops injecting the washing liquid when the washing liquid has been injected into the inner space 51 in a predetermined volumetric amount. That is, the controller 10 stops actuating the pump “P1.” The pressing force, which the spring 61 exerts toward the flow-in port 54, shifts the valve 56 to the side of the flow-in port 54, and then holds it at the position closest to the flow-in port 54. Specifically, the valve 56 shifts from the position shown in FIG. 10 to the other position shown in FIG. 9. The thus shifted valve 56 closes the flow passage 55 and exhaust flow passage 63. In other words, the inner space 51 turns into a closed space.

Moreover, the controller 10 opens the valve 70 of the compressed-air flow-in section 67, flowing the compressed air, which has been supplied from the pump “P2,” the gas source, to the compressed-air flowing port 68, into the inner space 51 via the compressed-air flow passage 69 shown in FIG. 12. The controller 10 closes the valve 70 to stop the compressed air flowing into the inner space 51 after allowing the inner space 51 to reserve the compressed air in a predetermined volumetric amount. On this occasion, the inner space 51 of the tank 5 reserves the washing liquid and compressed air under pressurized condition.

Thereafter, the controller 10 opens the nozzle 72. That is, the controller 10 commands or directs the presser 13 to press the valve 76 to shift. Specifically, the presser 13 shifts the valve 76 from the position shown in FIG. 9 to the other position shown in FIG. 11. The thus shifted valve 76 communicates between the through bore 78 of the valve 76, the inner space 51 and the spout port 51, forming the communication passage 73 in which the washing liquid flows. The washing liquid and compressed air reserved in the inner space 51 pass through the communication passage 73 and then spouts through the spout port 81, washing the lens surface “LS.”

The present washing device 1 according to Second Embodiment comprises the inner space 51 in which the washing liquid occupies the lower side and the compressed air occupies the upper side in the same manner as the present washing device 1 according to First Embodiment. The inner space 51 leads to pushing out the washing liquid by the compressed air and then spouting it through the spout port 81 with greater momentum in the same manner as First Embodiment. Then, the compressed air, which has been present above the washing liquid, spouts through the spout port 81. As having described so far, the present washing device 1 according to Second Embodiment removes foreign matters deposited on the lens surface “LS,” namely, washes the lens surface “LS.”

### Advantageous Effects of Second Embodiment

The present washing device 1 according to Second Embodiment pushes out the washing liquid with the compressed air, spouting the washing liquid through the spout port 81 with greater momentum as the present washing device 1 according to First Embodiment does. Then, the present washing device 1 spouts the compresses air, which has been present above the washing liquid within the inner space 51, through the spout port 81. Thus, Second Embodiment produces the same advantageous effects as those produced by First Embodiment. Moreover, the present washing device 1 comprises the tank 5 constructed to include the washing-liquid flow-in section 53 into which the washing liquid flows in, and the compressed-air flow-in section 67 into which the compressed air flows in. The thus constructed present washing device 1 allows flowing the washing liquid and compressed air into the tank 5, specifically, into the inner space 51 in the tank 5, independently of one another, and permits the tank 5 to reserve the pressurized washing liquid and compressed air.

Moreover, the present washing device 1 according to Second Embodiment comprises the tank 5 whose lower end is formed as configuration including the inclined face 79 for actively guiding the washing liquid to the nozzle 72 and communication passage 73. That is, the present washing device 1 allows preventing the washing liquid from remaining inside the tank 5 more effectively. The present washing device 1 permits making the volumetric amount of the washing liquid supplied into the tank 5 equal to a required volumetric amount of the washing liquid for blowing operation without taking the remaining volumetric amount of the washing liquid in the tank 5 into account, because the present washing device 1 makes it possible to blow a total volumetric amount of the washing liquid supplied into the tank 5 onto the lens surface “LS.” In other words, the present washing device 1 inhibits the washing liquid from being supplied into the tank 5 in an excessive volumetric amount, producing such an advantageous effect as washing the lens surface “LS” efficiently with a lesser volumetric amount of the washing liquid.

### Third Embodiment

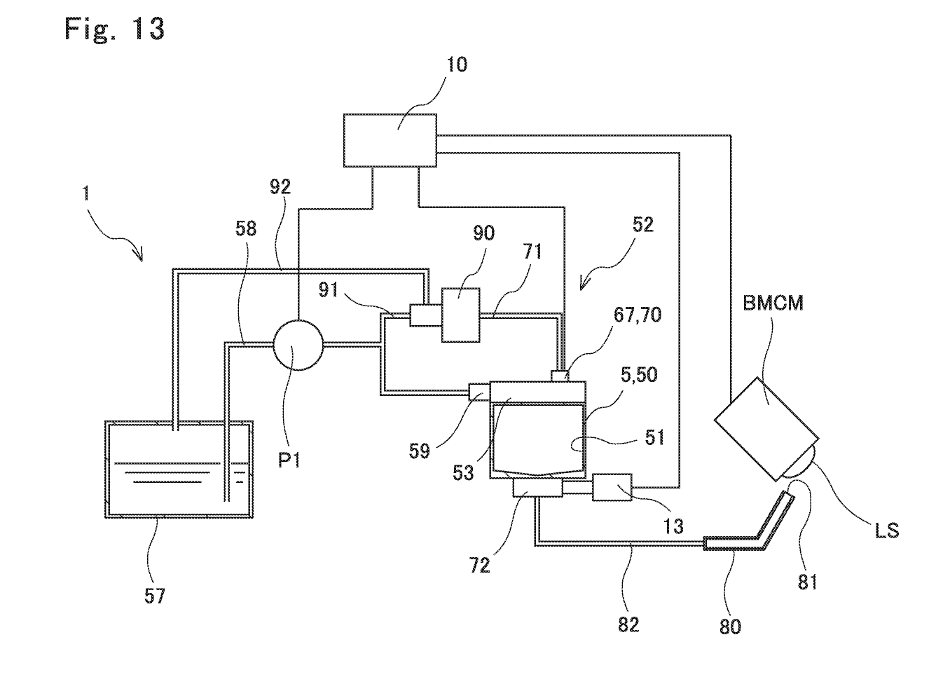

A washing device 1 for on-board camera according to Third Embodiment of the present invention is constructed as shown in FIG. 13. Unless referred to otherwise especially, the present washing device 1 according to Third Embodiment comprises the same constituents as those of Second Embodiment. FIG. 13 illustrates an overall construction of the present washing device 1 in a block diagram. As illustrated in the drawing, the present washing device 1 is constructed in the same manner as Second Embodiment, except that the washing-fluid introducer 52 including the washing-liquid flow-in section 53 and compressed-air flow-in section 67 is constructed as described below. In the drawing, the same constituent elements as those of Second Embodiment are specified with identical reference symbols shown in FIGS. 7 through 12.

The present washing device 1 according to Third Embodiment comprises the tank 5 including the flow-in port 54 connected with the washing-liquid tank 57. Specifically, the washing-liquid tank 57 is connected with the flow-in port 54 via the washing-liquid supply flow passage 58, pump “P1” and metering injector 59. Moreover, the tank 5 includes the compressed-air supply section 67 whose compressed-air flow-in port 68 is connected with a booster valve 90 instead of the pressurizer pump “P2.” The booster valve 90 functions in the same manner as the pressurizer pump “P2” according to Second Embodiment does. Specifically, the booster valve 90 not only produces the compressed air by compressing the external air, but also supplies the produced compressed air to the inner space 51 in the tank 5. The booster valve 90 producing the compressed air is actuated by a pressure resulting from the washing liquid supplied by the pump “P1.”

The booster valve 90 is connected with a second washing-liquid supply flow passage 91 connected with the washing-liquid supply flow passage 58 on the downstream side of the pump “P1.” The second washing-liquid supply flow passage 91 makes a flow passage for supplying the washing liquid supplied by the pump “P1” to the booster valve 90. The booster valve 90 is connected with the washing-liquid tank 57 via a washing-liquid circulation flow passage 92. The washing-liquid circulation flow passage 92 has an opposite end connected with the booster valve 92, and another opposite end connected with an upper part of the washing-liquid tank 57. The washing-liquid circulation flow passage 92 makes a flow passage for returning the washing liquid, which is supplied to the booster valve 90 via the second washing-liquid supply flow passage 91, to the washing-liquid tank 57. Each of the second washing-liquid supply flow passage 91 and washing-liquid circulation flow passage 92 is formed of a pipe in which the washing liquid flows.

### Operations of Third Embodiment

How the present washing device 1 according to Third Embodiment operates will be hereinafter described in the same manner as the operations of Second Embodiment. Note that no reference will be made herein especially to the same operations as those of Second Embodiment. In operating the present washing device 1, a driver, navigator or passenger of the vehicle “V” judges whether or not foreign matters deposit on the lens surface “LS” of the back-monitoring camera “BMCM” in the same manner as Second Embodiment. When the driver, navigator or passenger determines that foreign matters deposit on the lens surface “LS,” he or she operates a not-shown switch for the present washing device 1. The controller 10, which has received a signal from the operated switch, commands the presser 13 to hold the nozzle 72 under the condition that the valve 76 closes the nozzle 72.

Subsequently, the controller 10 not only actuates the pump “P1” but also commands the compressed-air flow-in section 67 so as to open the valve 70. The pump “P1” actuated by the controller 10 supplies the washing liquid held in the washing-liquid tank 57 to the metering injector 59 via the washing-liquid supply flow passage 58. Simultaneously, the pump “P1” supplies the washing liquid to the booster valve 90 via the second washing-liquid supply flow passage 91. The washing liquid supplied to the metering injector 59 via the washing-liquid supply flow passage 58 is supplied into the inner space 51.

The washing liquid supplied to the booster valve 90 via the second washing-liquid supply flow passage 91 actuates the booster valve 90. The booster valve 90 pressurizes the external air (or atmospheric air) to produce compressed air, and then supplies the produced compressed air to the compressed-air flow-in port 68 in the compressed-air flow-in section 67 of the tank 5, flowing the compressed air into the inner space 51. The washing liquid used to actuate the booster valve 90 returns of itself to the washing-liquid tank 57 via the washing-liquid circulation flow passage 92. Thus, the inner space 51 within the tank reserves the washing liquid and compressed air under pressurized condition.

Thereafter, the controller 10 opens the nozzle 72. That is, the controller 10 commands the presser 13 to press the valve 76 to shift. The shifted valve 76 communicates between the through bore 78 of the valve 76, the inner space 51 and the spout port 81, forming the communication passage 73 in which the washing liquid flows. The washing liquid and compressed air reserved in the inner space 51 pass through the communication passage 73 and then spouts through the spout port 81, washing the lens surface “LS.” The present washing device 1 according to Third Embodiment removes foreign matters deposited on the lens surface “LS,” namely, washes the lens surface “LS” in the above-described manner.

### Advantageous Effects of Third Embodiment

The present washing device 1 according to Third Embodiment produces the same advantageous effects as those produced by the present washing device 1 according to Second Embodiment. Moreover, the present washing device 1 according to Third Embodiment comprises the one-and-only pump “P1” that not only allows supplying the washing liquid but also permits producing and supplying the compressed air. That is, the one-and-only pump “P1” enables the present washing device 1 according to Third Embodiment to demonstrate the enhanced washing effects without ever complicating it structurally.

### Modified Embodiments

Although First through Third Embodiments wash the lens surface “LS” of the back-monitoring camera “BMCM” for the vehicle “V,” they are not at all limited to washing the back-monitoring camera “BMCM” dealing with visible lights. For example, First through Third Embodiments are also satisfactorily applied to cameras or devices receiving and transmitting invisible lights such as millimeter waves and electromagnetic waves. In this instance, the lens surface “LS” makes a transmissive cover surface that the cameras or devices receiving and transmitting invisible lights have, and through which the invisible lights, for instance, millimeter waves transmit. That is, the term, “on-board camera,” involves the cameras or devices receiving and transmitting invisible lights such as millimeter waves and electromagnetic waves. Moreover, although First through Third Embodiments disclose the mode of arranging the lens surface “LS” above the rear-face license plate of the vehicle “V,” they do not at all limit where the cameras or devices are mounted, either. For example, the cameras or devices are also satisfactorily arranged on the front face, rear face, side faces or roof of the vehicle “V.”

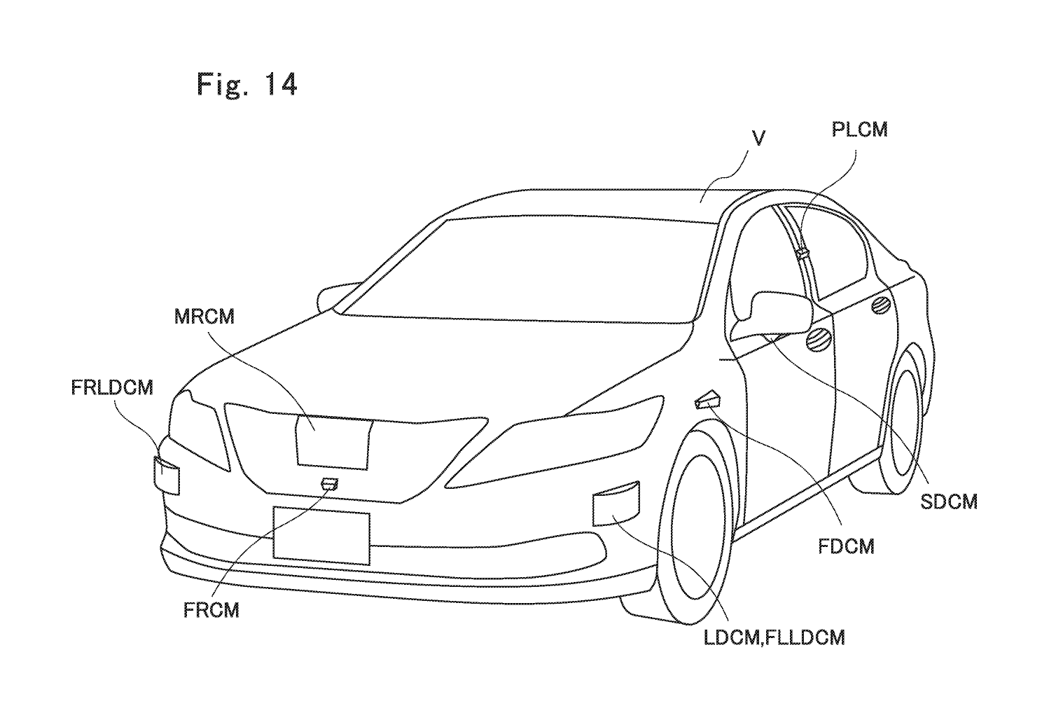

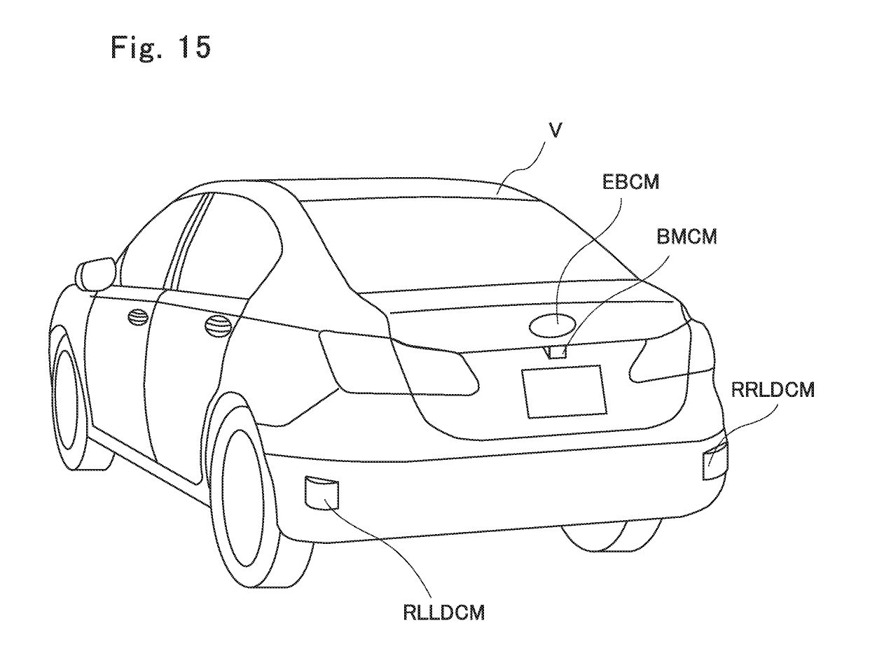

Specifically, the cameras or devices, which are worth enumerating, involve cameras shown in FIGS. 14 and 15. FIG. 14 illustrates the vehicle “V” in a perspective view when viewed on the diagonally forward left side. FIG. 15 illustrates the vehicle “V” in a perspective view when viewed on the diagonally rearward left side. As illustrated in the drawings, the following are exemplifiable cameras or devices: a millimeter-wave radar MRCM; laser imaging detection and ranging (or “LIDR”) devices “LDCM,” such as “FRLDCM,” “FLLDCM,” “RRLDCM” and “RLLDCN”; a side camera “SDCM”; a front camera “FRCM”; a fender camera “FDCM”; a pillar camera “PLCM”; a rear emblem camera “EBCM”; and the back-monitoring camera “BMCM” to which the above-described embodiments are applied. The millimeter-wave radar “MRCM” with which the vehicle “V” is equipped at the middle in the front-face grill not only transmits a millimeter wave ahead of the vehicle “V,” but also receives reflective waves reflected by the forward objects.

An “LIDAR” device “LDCM” is a device that emits a laser light beam in a pulsated manner and receives reflective waves of the laser light beam. As illustrated in FIGS. 14 and 15, the vehicle “V” can be equipped with the “LIDAR” devices “LDCM” at the four corners. As illustrated in FIG. 14, an “LIDAR” device “FRLDCM” for front right corner is installed at the front right corner of the vehicle “V,” and an “LIDAR” device “FLLDCM” for front left corner is installed at the front left corner. Moreover, as illustrated in FIG. 15, an “LIDAR” device “RRLDCM” for rear right corner is installed at the rear right corner of the vehicle “V,” and an “LIDAR” device “RLLDCM” for rear left corner is installed at the rear left corner.

The side camera “SDCM” shoots or makes a video of from one of the sides of the vehicle “V” to the rear. The vehicle “V” is equipped with the side camera “SDCM” on one of the side faces. Specifically, the side camera “SDCM” is installed on the lower face in the left-hand outside mirror of the vehicle “V” as shown in FIG. 14. The front camera “FRCM” shoots or makes a video of from the front of the vehicle “V” to both of the sides. The vehicle “V” is equipped with the front camera “FRCM” at the middle in the front-face grill as shown in the drawing. The fender camera “FDCM” shoots or makes a video of from one of the sides of the vehicle “V” to the rear. The vehicle “V” is equipped with the fender cameras “FDCM” on one of the side faces. Specifically, the side camera “FDCM” is installed above the left-hand fender of the vehicle “V” as shown in the drawing.

Moreover, the pillar camera “ PLCM” shoots or makes a video of from one of the sides of the vehicle “V” to the rear. The vehicle “V” is equipped with the pillar camera “ PLCM” on the left-hand pillar, specifically, on the left-hand “B” or center pillar as shown in FIG. 14. In addition, the rear emblem camera “EBCM” shoots or makes a video of the rear of the vehicle “V.” The vehicle “V” is equipped with the rear emblem camera “EBCM” in the rear-face emblem as shown in FIG. 15. It is possible for the present washing devices according to above-described First through Third Embodiments, which are applied to washing the lens surface “LS” of the above-exemplified cameras or devices, to demonstrate the same advantageous effects as those described above.

Having now fully described the present invention, it will be apparent to one of ordinary skill in the art that many changes and modifications can be made thereto without departing from the spirit or scope of the present invention as set forth herein including the appended claims.

What is claimed is:

1. A washing device for on-board camera, the washing device washing a lens surface of a camera installed on a vehicle, and comprising:
a spout port directed to the lens surface, and spouting a washing liquid and compressed air;
a tank communicating with the spout port, and reserving the washing liquid and compressed air under pressurized condition; and
a controller controlling the washing liquid and compressed air reserved in the tank so as to spout through the spout port.

2. The washing device according to claim 1 further comprising:
a communication passage communicating the tank with the spout hole; and
a valve controlling distribution of the washing liquid and the compressed air which flow in the communication passage;
wherein the communication passage includes an end disposed on a side of the tank, and located on a lower side than a side on which a liquid level of the washing liquid reserved in the tank is located.

3. The washing device according to claim 1, wherein the tank includes:
a cylinder; and
a piston reciprocating inside the cylinder.

4. The washing device according to claim 1, wherein the tank includes:
a washing-liquid flow-in section into which the washing liquid flows in; and
a compressed-air flow-in section into which the compressed air flows in.

5. The washing device according to claim 4, wherein:
the washing-liquid flow-in section includes a first nozzle, and a first valve opening and closing the first nozzle, thereby allowing and disallowing the washing liquid to flow into the tank; and
the compressed-air flow-in section includes a second nozzle, and a second valve opening and closing the second nozzle, thereby allowing and disallowing the compressed air to flow into the tank.

6. The washing device according to claim 5, wherein:
the first nozzle is provided with a first exhaust through bore communicating with an exterior thereof, and a second exhaust through bore communicating with the tank; and
the first valve is provided with a third exhaust through bore;
wherein the third exhaust through bore communicates the first exhaust through bore with the second exhaust through bore when the first nozzle and first valve allow the washing liquid to flow into the tank, thereby exhausting the tank.

7. The washing device according to claim 4 further comprising a fluid supplier supplying the compressed air to the compressed-air flow-in section as well as supplying the washing liquid to the washing-liquid flow-in section.

8. The washing device according to claim 7, wherein the fluid supplier includes:
a booster valve connected with the compressed-air flow-in section, taking in external air thereof, producing and then supplying the compressed air to the compressed-air flow-in section;
a pump connected with the booster valve and with the washing-liquid flow-in section, and delivering the washing liquid to the booster valve and to the washing-liquid flow-in section; and
a washing-liquid tank connected with the pump.

9. The washing device according to claim 1, wherein the tank includes a nonreturn valve inhibiting the compressed air from flowing backward.

10. The washing device according to claim 1, wherein the tank includes a check valve inhibiting the washing liquid from flowing backward.
